(19) United States
(12) Patent Application Publication
(10) Pub. No.: US 2026/0092471 A1
(43) Pub. Date: Apr. 2, 2026

(54) MERCHANDISER DOOR WITH DIGITAL DOOR HANDLE

(71) Applicant: Hussmann Corporation, Bridgeton, MO (US)

(72) Inventors: Michael Patrick Flynn, Defiance, MO (US); Cody J. Schollmeyer, Wentzville, MO (US); John William Boswell, Ballwin, MO (US)

(21) Appl. No.: 19/346,738

(22) Filed: Oct. 1, 2025

Related U.S. Application Data
(60) Provisional application No. 63/701,997, filed on Oct. 1, 2024.

(51) Int. Cl. E05B 1/00; F25D 23/02

(52) U.S. Cl. CPC E05B 1/0084; F25D 23/028

(57) ABSTRACT

A device may include a main body including a first end and a second end, and an axis extending along the main body between the first end to the second end. A device may include a handle coupled to the main body adjacent to or at the second end and configured to enable a user to open the door via engagement of the handle. A device may include a display support coupled to the main body adjacent to the first end and defining a display slot accessible at the first end and extending along the axis. A device may include a digital display assembly coupled to the display support and engaged within the display slot, the digital display assembly disposed above the handle and including a display and a power source configured to provide power to the display.

### CROSS-REFERENCE TO RELATED APPLICATION

The present invention claims priority to U.S. Provisional Patent Application No. 63/701,997, filed on October 1, 2024, and entitled “MERCHANDISER DOOR WITH DIGITAL DOOR HANDLE,” the content of which is hereby incorporated by reference in its entirety.

### BACKGROUND

The present invention relates to merchandiser or display cases, and more specifically, a digital door handle for merchandisers.

Refrigeration systems are well known and widely used in supermarkets and warehouses to refrigerate food product displayed in a product display area of a refrigerated merchandiser or display case. Merchandisers commonly include a door and a handle to open the door.

### SUMMARY

In some aspects, the techniques described herein relate to a handle system for a door, the handle system including: a main body including a first end and a second end, and an axis extending along the main body between the first end to the second end; a handle coupled to the main body adjacent to or at the second end and configured to enable a user to open the door via engagement of the handle; a display support coupled to the main body adjacent to the first end and defining a display slot accessible at the first end and extending along the axis; and a digital display assembly coupled to the display support and engaged within the display slot, the digital display assembly disposed above the handle and including a display and a power source configured to provide power to the display.

In some aspects, the techniques described herein relate to a handle system, wherein the display support is defined as part of the main body above the handle in a use orientation of the handle system.

In some aspects, the techniques described herein relate to a handle system, wherein the main body further includes a stem disposed between the handle and the display support, and wherein the display slot terminates at a juncture between the display support and the stem.

In some aspects, the techniques described herein relate to a handle system, further including a stop disposed at or adjacent the juncture, wherein the digital display assembly is configured to engage the stop on full insertion of the digital display assembly within the display slot.

In some aspects, the techniques described herein relate to a handle system, wherein the display support further defines grooves in communication with respective lateral sides of the display slot, and wherein a portion of the digital display assembly is disposed in the grooves on engagement of the digital display assembly within the display slot.

In some aspects, the techniques described herein relate to a handle system, wherein the main body further includes a stem disposed between the handle and the display support, and wherein the grooves define blind slots that terminate before a juncture between the display support and the stem.

In some aspects, the techniques described herein relate to a handle system, wherein the digital display assembly is engaged with ends of the blind slots on full insertion into the display slot to hold the digital display assembly on the display support.

In some aspects, the techniques described herein relate to a handle for a door, the handle including: a main body including a first end and a second end, and an axis extending along a longitudinal center of the main body between the first end to the second end, the main body including: a handle coupled to the main body adjacent to or at the second end and configured to enable a user to open the door via engagement of the handle; and a display support coupled to the main body adjacent to the first end and defining a display slot accessible at or adjacent the first end and extending along the axis, the display slot extending through at least a portion of the display support and configured to be engaged by a digital display assembly, the display slot arranged laterally off-center on the display support.

In some aspects, the techniques described herein relate to a handle, wherein the display slot extends along the axis through an entirety of the display support.

In some aspects, the techniques described herein relate to a handle, wherein the display support is defined as part of the main body above the handle in a use orientation of the handle.

In some aspects, the techniques described herein relate to a handle, wherein the main body further includes a stem disposed between the handle and the display support, and wherein the display slot terminates at a juncture between the display support and the stem.

In some aspects, the techniques described herein relate to a handle, further including a stop disposed at or adjacent the juncture and configured to be engaged by the digital display assembly on full insertion of the digital display assembly into the display slot.

In some aspects, the techniques described herein relate to a handle, wherein the display support further defines grooves in communication with respective lateral sides of the display slot, and wherein the grooves are configured to be engaged by the digital display assembly.

In some aspects, the techniques described herein relate to a handle, wherein the main body further includes a stem disposed between the handle and the display support, and wherein the grooves define blind slots that terminate before a juncture between the display support and the stem.

In some aspects, the techniques described herein relate to a handle system for a door, the handle system including: a main body including a first end and a second end, and an axis extending along a longitudinal center of the main body between the first end to the second end; a handle coupled to the main body adjacent to or at the second end and configured to enable a user to open the door via engagement of the handle; a display support coupled to the main body adjacent to the first end and defining a display slot accessible at the first end and extending along the axis; and a digital display assembly coupled to the display support, the digital display assembly including a housing supporting a display and a power source configured to provide power to the display, and the housing having a rail disposed within the display slot.

In some aspects, the techniques described herein relate to a handle system, wherein the housing substantially covers an entirety of an exterior face of the display support.

In some aspects, the techniques described herein relate to a handle system, wherein the rail includes lateral projections and the display support further includes grooves adjacent lateral edges of the display slot, and wherein the rail is engaged with the grooves on engagement of the digital display assembly within the display slot.

In some aspects, the techniques described herein relate to a handle system, wherein the main body further includes a stem disposed between the handle and the display support, and wherein the grooves define blind slots that terminate before a juncture between the display support and the stem.

In some aspects, the techniques described herein relate to a handle system, wherein the display slot is arranged laterally off-center on the display support.

In some aspects, the techniques described herein relate to a handle system, wherein the rail is offset to a side of the housing relative to a longitudinal center of the housing.

Other aspects of the invention will become apparent by consideration of the detailed description and accompanying drawings.

### BRIEF DESCRIPTION OF THE DRAWINGS

FIG. 1 is a perspective view of a digital door handle in accordance with an embodiment of the disclosure, illustrating the digital door handle coupled to a merchandiser.

FIG. 2 is an exploded perspective view of the digital door handle of FIG. 1, illustrating a main body and a digital display assembly.

FIG. 3 is a cross-sectional view of the digital door handle along line 3—3 of FIG. 2, illustrating the digital display received by the main body.

FIG. 4 is a cross-sectional view of the digital door handle along line 4—4 of FIG. 2, illustrating the digital display received by the main body.

FIG. 5 is an enlarged perspective view of the digital door handle of FIG. 2, illustrating a stop tab on the main body that interfaces with the digital display assembly.

FIG. 6 is an enlarged perspective view of the digital door handle of FIG. 2, illustrating the digital display assembly removed from the main body.

FIG. 7 is another enlarged perspective view of the digital door handle of FIG. 2, illustrating the digital display assembly removed from the main body.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially” include values within ten percent greater or less than the stated value. When used in the context of an angle or direction, such terms include within ten degrees greater or less than the stated angle or direction. For example, “generally vertical” includes directions within ten degrees of vertical in any direction (e.g., clockwise or counter-clockwise).

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

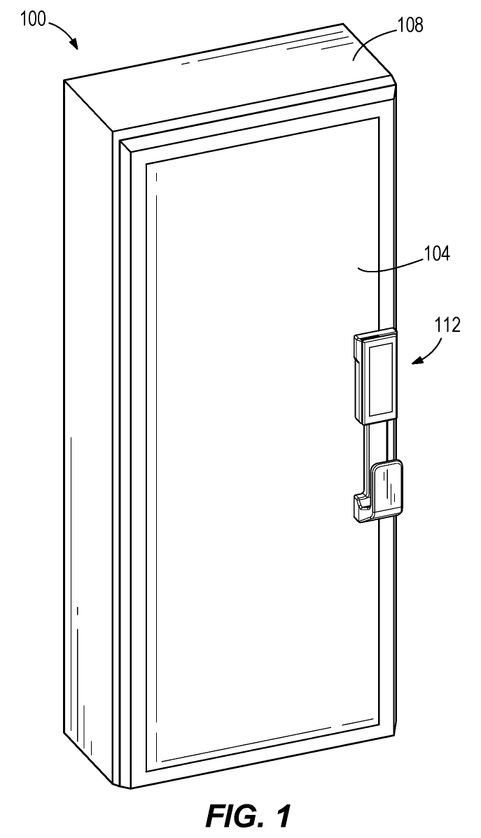

FIG. 1 illustrates a display case or merchandiser 100 (e.g., cooler, refrigerator, refrigerated cases, etc.) including a door 104 pivotably coupled to a refrigerator housing 108. In the illustrated example, the door 104 is at least partially composed of glass to display contents and allow customers to see the contents inside the merchandiser 100. The door 104 is movable between a closed position (as illustrated in FIG. 1), in which the contents inside the merchandiser 100 are not accessible to a customer, and an open position, in which the contents inside the merchandiser are accessible to a customer. A door handle or handle system or handle assembly 112 (referred to in the Detailed Description as a ‘handle system’ for ease of description) is provided to facilitate moving the door 104 between the closed position and the open position.

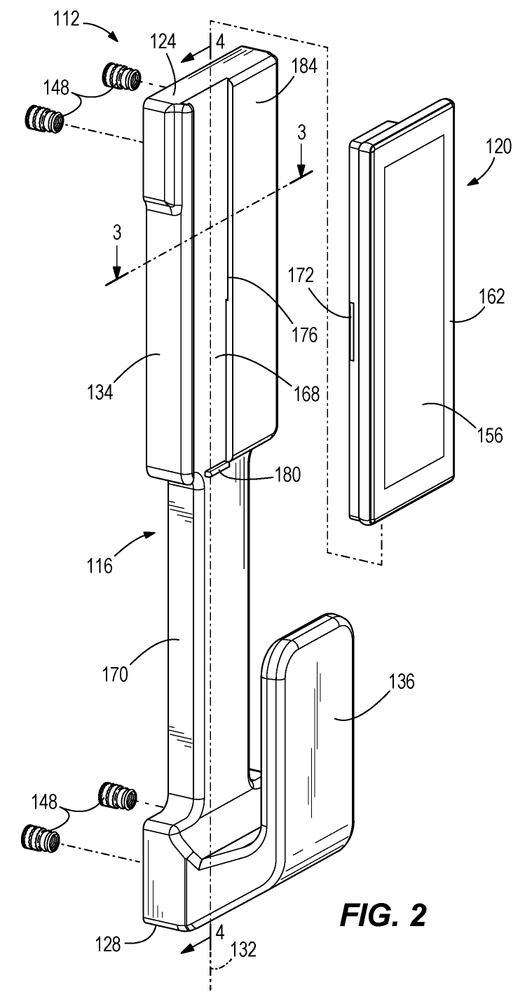

With reference to FIGS. 1 and 2, the handle system 112 takes the form of a digital door handle including a main body 116 and a digital display assembly 120 that is removably coupled to the main body 116. The main body 116 includes first end 124, a second end 128, and a longitudinal axis 132 extending between the first end 124 and the second end 128 at the longitudinal center of the main body 116. The main body 116 further includes a display support 134 adjacent the first end 124 and a handle or actuator 136 (referred to in the Detailed Description as a ‘handle’ for ease of description) adjacent to or at the second end 128 that enables a user to open the door via engagement of the handle 136. The display support 134 is configured to receive and support the digital display assembly 120 and the handle 136 is graspable by a customer to facilitate opening and closing the door 104. The display support 134 may be coupled to the main body 116 as a separate element, or the display support may be defined as part of the main body 116). As illustrated, the display support 134 is located above the handle system 112 in a use orientation of the handle system 112. The handle 136 is cantilevered from the second end 128 in such a manner that the handle 136 is spaced away from the main body 116, and the handle 136 extends along a direction parallel to the longitudinal axis 132. Also, the handle 136 extends in a direction from the second end 128 toward the first end 124. Because the handle 136 is cantilevered from the second end 128, the handle 136 includes a free, distal end extending toward the digital display assembly 120 (in the illustrated example, the handle 136 does not overlap the digital display assembly 120). In some examples, the handle 136 may pivot relative to the main body 116 to facilitate opening the door 104.

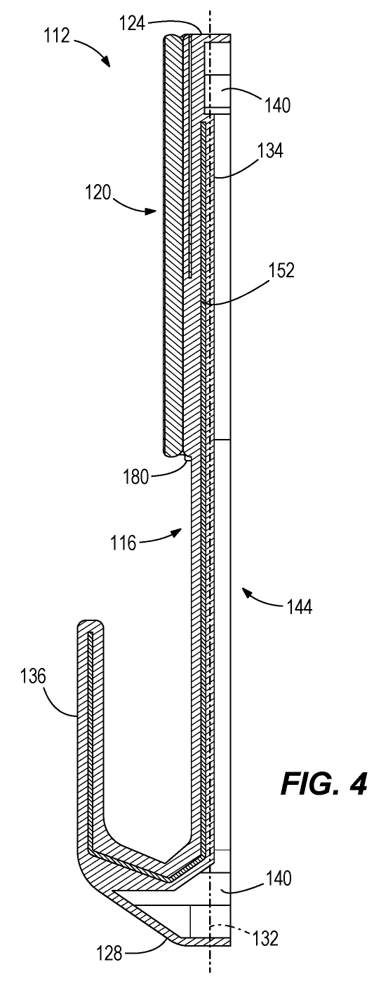

With reference to FIGS. 2 and 4, the main body 116 further includes counterbores 140 on a rear face 144 of the main body 116. Each counterbore 140 receives a corresponding threaded insert 148. In some examples, the handle system 112 may be coupled to the door 104 via fasteners that are inserted through the door 104 and threadably engaged with the threaded inserts 148. In the illustrated example, and with reference to FIG. 4, a structural support member 152 is disposed within the main body 116 to provide increased strength, rigidity, and/or support to the main body 116. The structural support member 152 extends from adjacent the second end 128 toward or to the first end 124 and through the handle 136.

With reference to FIGS. 2-5, the digital display assembly 120 includes an e-paper display 156 (i.e., e-ink display, electronic shelf label or ESL, etc.) and a power source 160. The illustrated e-paper display 156 is a four-color digital display (i.e., red, yellow, white, and black). In other examples, the e-paper display 156 may display more than four colors, less than four colors, or may be monochrome. The e-paper display 156 may display, for example, one or more of an image of the contents (e.g., goods) inside the merchandiser 100, price of the goods, discounts associated with the purchase of the goods, SKU numbers associated with the goods, quantity of the goods, or other relevant information (e.g., as a single, static picture). As is common with e-paper displays, the e-paper display 156 is capable of displaying a static picture for long periods of time without the use of electrical power. The only time the e-paper display 156 needs electrical power (e.g., from the power source 160) is to switch the picture that is displayed. Thus, the illustrated power source 160 is a battery, and preferably a rechargeable, low-voltage battery. However, in some embodiments, the power source 160 may be omitted since a remote power source may be coupled to the e-paper display 156 to switch the picture being displayed.

Due to the on-board power source 160, the handle system 112 does not require a wiring harness, a conduit for wires, or other electrical leads to extend from the door 104 to the handle system 112. This makes installation of the handle system 112 simple compared to existing displays. In some examples, the digital display assembly 120 may include a near-field communication (NFC) device, temperature sensors, and/or geolocation capabilities. The digital display assembly 120 may be watertight to inhibit inadvertent ingress of liquid and other debris.

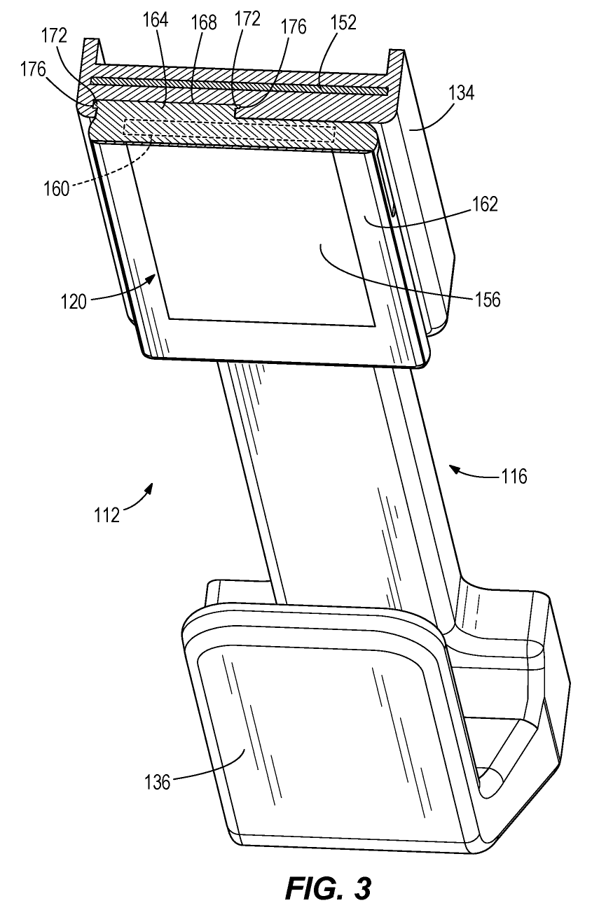

With continued reference to FIGS. 2-5, the digital display assembly 120 includes a housing 162 that receives and supports the e-paper display 156 and the power source 160. As shown, the housing 162 supports the e-paper display 156 and the power source 160 relative to the remainder of the handle system 112. With reference to FIG. 3, the housing 162 includes a rail 164 that extends from the housing 162 (a rear side of the housing 162 as viewed in FIG. 3), and the housing 162 is slidably coupled to the handle system 112 via engagement of the rail 164 within a recessed slot 168 of the handle system 112. As shown, the rail 164 is offset to one side of the housing 162 (i.e. a longitudinal center of the housing 162) so that the digital display assembly 120 is centered on the display support 134 when the recessed slot 168 is off-center. In some examples, it will be appreciated that the rail 164 may be centered on the housing 162.

With reference to FIGS. 2, 6, and FIG. 7 , the recessed slot 168 (referred to as a ‘display slot’ in at least some claims) is disposed on the display support 134 and extends along a direction parallel to the longitudinal axis 132. In the illustrated non-limiting example, the recessed slot 168 has an edge that is disposed at or adjacent the longitudinal axis 132 such that the recessed slot 168 is laterally arranged on the display support 134 (i.e. the recessed slot 168 is off-center on the display support 134 relative to the longitudinal axis 132). That is, the recessed slot 168 is arranged to one side, or substantially to one side, of the longitudinal axis 132. In other examples, the recessed slot 168 may be centered on the display support 134 (centered on the longitudinal axis 132).

The recessed slot 168 may be a blind slot that extends only partially through the display support 134 along the longitudinal axis 132 (e.g., downward as viewed in FIG. 4). In this example, the depth of the recessed slot 168 along the longitudinal axis is defined so that the top of the digital display assembly 120 is aligned (e.g., substantially aligned) with a top of the display support 134. In some examples, the recessed slot 168 may extend entirely through the display support 134 in the direction parallel with the longitudinal axis 132. In these latter examples, and with reference to FIGS. 4-7, the display support 134 may include a stop tab 180 (best illustrated in FIGS. 4-7) that is disposed at a distal end or an inward end of the recessed slot 168. The stop tab 180 may be disposed or located adjacent to or at the juncture of the display support 134 and a stem 170 of the main body 116 between the display support 134 and the handle 136 (e.g., to inhibit the digital display assembly 120 from slipping or sliding through the display support 134).

The rail 164 includes a pair of projections 172 that extend outward from the rail 164 (i.e. laterally or in the width direction of the digital display assembly 120 as viewed in FIG. 3). The projections 172 are shaped to mate and engage with corresponding grooves 176 defined in the display support 134 adjacent to opposite lateral edges of the recessed slot 168 to secure the digital display assembly 120 on the handle system 112. The grooves 176 are in communication with the lateral sides of the recessed slot 168 and extend from the first end toward or to the juncture between the display support 134 and the stem 170. As shown, and in one non-limiting example, the grooves 176 define blind slots in the display support 134 such that the grooves 176 terminate before the juncture between the display support 134 and the stem 170. The depth of the grooves 176 along the longitudinal axis 132 correspond to the location of the projections 172 so that the projections 172 are engaged with the bottom of the grooves 176 on full insertion of the digital display assembly 120 into the display support 134. The arrangement of the display support 134 within the recessed slot 168 prevents lateral movement of the digital display assembly 120 relative to the display support 134 after the digital display assembly 120 is fully inserted into the display support 134, and the arrangement holds the digital display assembly 120 in place during use of the handle 136.

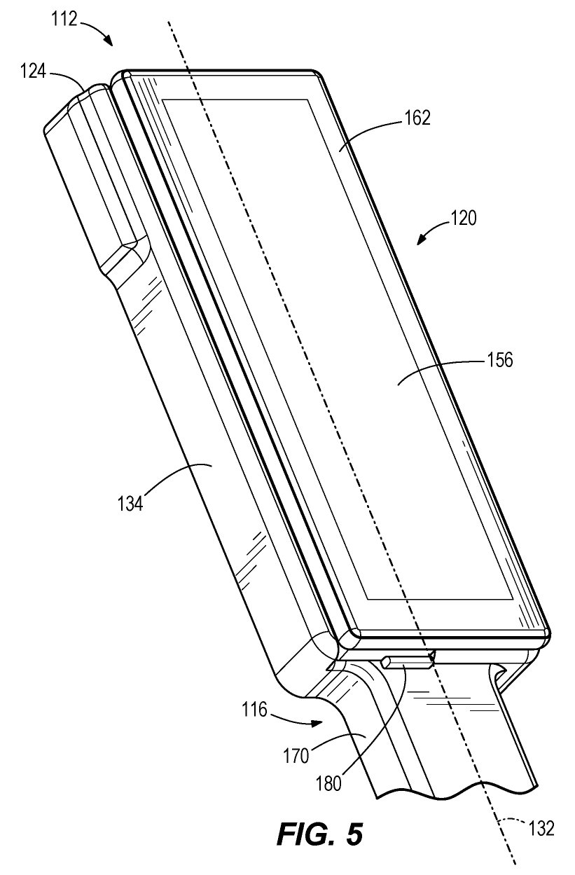

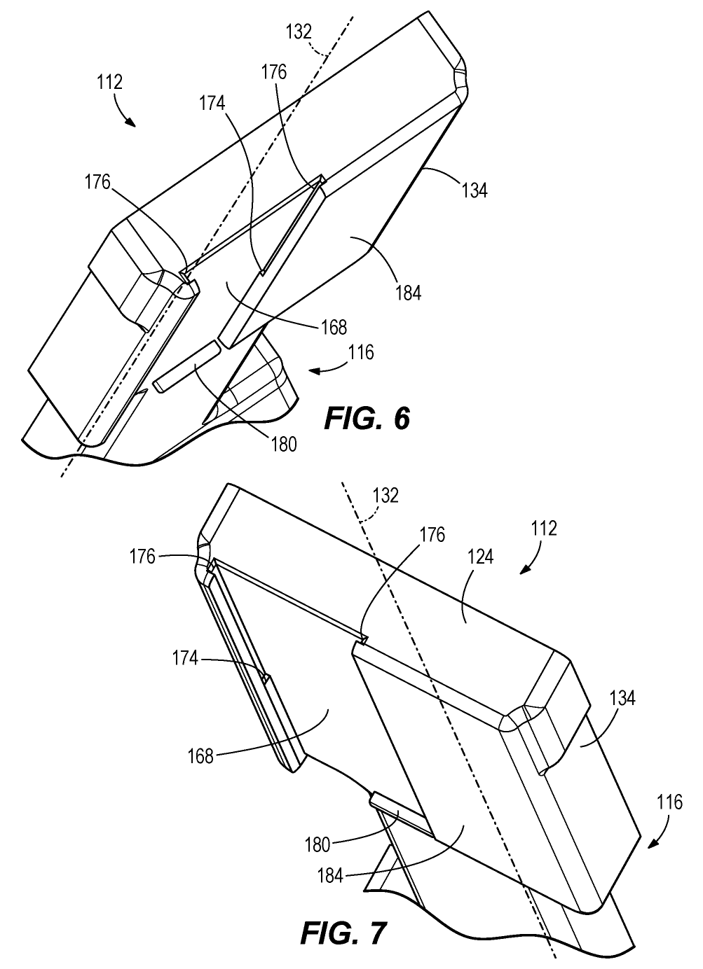

The projections 172 and the grooves 176 interface to provide a press-fit, snap-fit, or other positive engagement to maintain the connection between the digital display assembly 120 and the handle system 112. To assemble the digital display assembly 120 on the handle system 112, the rail 164 is aligned with the recessed slot 168, at which point the digital display assembly 120 is slid along the longitudinal axis 132 (from the first end 124 toward the second end 128) into the display support 134 until the projections 172 are fully engaged within of the grooves 176. With reference to FIGS. 6 and 7 and the example including blind grooves 176, the projections 172 may engage opposite ledges 174 (FIGS. 6 and 7) that define the inner ends of the grooves 176. The housing 162 may abut the stop tab 180 on full insertion of the digital display assembly 120 into the display support 134. That is, the stop tab 180 inhibits the digital display assembly 120 from moving further along the longitudinal axis 132 toward the second end 128. As best shown in FIGS. 1 and 5, the digital display assembly 120 (e.g., the housing 162) covers a front or exterior face 184 of the display support 134 (opposite the rear face 144 with the counterbores 140), or substantially all of the front face on full insertion of the digital display assembly 120 into the recessed slot 168.

It will be appreciated that the digital display assembly 120 may be attached to the display support 134 by positioning one projection 172 of the rail 164 into a corresponding groove 176 and thereafter snapping the other projection 172 into the corresponding groove 176. That is, the digital display assembly 120 may be attached to the display support 134 from adjacent the front face of the display support 134 rather than from the first end of the main body 116. For example, the projection 172 designed to be arranged closest to the longitudinal axis 132 may be snapped into the interior-most groove 176 after the interior projection 172 is arranged in the interior groove 176, and then the other projection 172 (i.e. the projection 172 designed to be arranged farthest from the longitudinal axis 132) may be snapped into the corresponding groove 176. Angular surfaces on the projections 172 or on the surfaces defining the opening to the grooves 176 may facilitate this snap-fit arrangement.

Although the digital door handle has been described in detail with reference to certain examples, variations and modifications exist within the scope and spirit of one or more independent aspects of the disclosure as described.

Various features and advantages of the invention are set forth in the following claims.

1. A handle system for a door, the handle system comprising:
a main body including a first end and a second end, and an axis extending along the main body between the first end to the second end;
a handle coupled to the main body adjacent to or at the second end and configured to enable a user to open the door via engagement of the handle;
a display support coupled to the main body adjacent to the first end and defining a display slot accessible at the first end and extending along the axis; and
a digital display assembly coupled to the display support and engaged within the display slot, the digital display assembly disposed above the handle and including a display and a power source configured to provide power to the display.

2. The handle system of claim 1, wherein the display support is defined as part of the main body above the handle in a use orientation of the handle system.

3. The handle system of claim 1, wherein the main body further includes a stem disposed between the handle and the display support, and wherein the display slot terminates at a juncture between the display support and the stem.

4. The handle system of claim 3, further comprising a stop disposed at or adjacent the juncture, wherein the digital display assembly is configured to engage the stop on full insertion of the digital display assembly within the display slot.

5. The handle system of claim 1, wherein the display support further defines grooves in communication with respective lateral sides of the display slot, and wherein a portion of the digital display assembly is disposed in the grooves on engagement of the digital display assembly within the display slot.

6. The handle system of claim 5, wherein the main body further includes a stem disposed between the handle and the display support, and wherein the grooves define blind slots that terminate before a juncture between the display support and the stem.

7. The handle system of claim 6, wherein the digital display assembly is engaged with ends of the blind slots on full insertion into the display slot to hold the digital display assembly on the display support.

8. A handle for a door, the handle comprising:
a main body including a first end and a second end, and an axis extending along a longitudinal center of the main body between the first end to the second end, the main body including:
a handle coupled to the main body adjacent to or at the second end and configured to enable a user to open the door via engagement of the handle; and
a display support coupled to the main body adjacent to the first end and defining a display slot accessible at or adjacent the first end and extending along the axis, the display slot extending through at least a portion of the display support and configured to be engaged by a digital display assembly, the display slot arranged laterally off-center on the display support.

9. The handle of claim 8, wherein the display slot extends along the axis through an entirety of the display support.

10. The handle of claim 8, wherein the display support is defined as part of the main body above the handle in a use orientation of the handle.

11. The handle of claim 8, wherein the main body further includes a stem disposed between the handle and the display support, and wherein the display slot terminates at a juncture between the display support and the stem.

12. The handle of claim 11, further comprising a stop disposed at or adjacent the juncture and configured to be engaged by the digital display assembly on full insertion of the digital display assembly into the display slot.

13. The handle of claim 8, wherein the display support further defines grooves in communication with respective lateral sides of the display slot, and wherein the grooves are configured to be engaged by the digital display assembly.

14. The handle of claim 13, wherein the main body further includes a stem disposed between the handle and the display support, and wherein the grooves define blind slots that terminate before a juncture between the display support and the stem.

15. A handle system for a door, the handle system comprising:
a main body including a first end and a second end, and an axis extending along a longitudinal center of the main body between the first end to the second end;
a handle coupled to the main body adjacent to or at the second end and configured to enable a user to open the door via engagement of the handle;
a display support coupled to the main body adjacent to the first end and defining a display slot accessible at the first end and extending along the axis; and
a digital display assembly coupled to the display support, the digital display assembly including a housing supporting a display and a power source configured to provide power to the display, and the housing having a rail disposed within the display slot.

16. The handle system of claim 15, wherein the housing substantially covers an entirety of an exterior face of the display support.

17. The handle system of claim 15, wherein the rail includes lateral projections and the display support further includes grooves adjacent lateral edges of the display slot, and wherein the rail is engaged with the grooves on engagement of the digital display assembly within the display slot.

18. The handle system of claim 17, wherein the main body further includes a stem disposed between the handle and the display support, and wherein the grooves define blind slots that terminate before a juncture between the display support and the stem.

19. The handle system of claim 15, wherein the display slot is arranged laterally off-center on the display support.

20. The handle system of claim 19, wherein the rail is offset to a side of the housing relative to a longitudinal center of the housing.
